(19) United States
(12) Patent Application Publication
(10) Pub. No.: US 2007/0168422 A1
(43) Pub. Date: Jul. 19, 2007

(54) Method and system for providing selective media data in multimedia conference service

(76) Inventors: Mi-Ra Choe, Suwon--si (KR); Kwang-Yong Choi, Suwon-si (KR); Myeon-Kee Youn, Namdong-gu (KR); Seong-Joon Jeon, Yongin-si (KR)

Correspondence Address: Robert E. Bushnell, Suite 300, 1522 K Street, N.W., Washington, DC, 20005-1202, US

(21) Appl. No.: 11/523,581

(22) Filed: Sep. 20, 2006

(30) Foreign Application Priority Data
Jan. 16, 2006 (KR) 10-2006-0004563

(51) Int. Cl. G06F 15/16

(52) U.S. Cl. 709/204

(57) ABSTRACT

In a method and system for providing selective media data in a multimedia conference service, a selective media data provision request of a participant who wants to be selectively provided with media data is transmitted to a media server using Session Initiation Protocol (SIP), and media data selected or converted according to the request to the user are provided, thereby improving user convenience.

### CLAIM OF PRIORITY

This application makes reference to, incorporates the same herein, and claims all benefits accruing under 35 U.S.C.§119 from an application for METHOD AND SYSTEM FOR PROVIDING THE DIFFERENTIAL MEDIA DATA OF MULTIMEDIA CONFERENCE earlier filed in the Korean Intellectual Property Office on the 16^{th} of January 2006 and there duly assigned Serial No. 10-2006-0004563.

### BACKGROUND OF THE INVENTION

1. Technical Field

The present invention relates to a method and system for providing selective media data in a-multimedia conference service.

2. Related Art

A multimedia conference service enables a plurality of participants (generally three or more) to participate together in one session and to have a teleconference through a network. An early multimedia conference service was implemented using H.323 as a signaling protocol, but a current multimedia conference service is being changed to be implemented using Session Initiation Protocol (SIP)/SIP Project Investigation (SIPPING) protocol.

In general, a multimedia conference system is implemented so that an Application Server (AS) manages dialog information relating to signals of terminals participating in a multimedia conference, and a Media Server (MS) mixes media data collected from the terminals participating in the corresponding multimedia conference and provides the mixed media data to the terminals in a lump.

According to a multimedia conference scenario, media data of conference participants is collected, mixed by an MS, and provided to the participants in a lump. Therefore, it is not possible to be provided with a custom conference service suited to a participant's purpose such as listening only to a specific participant's speech selectively differentiated from the speech of other participants in the multimedia conference.

### SUMMARY OF THE INVENTION

It is an object of the present invention to provide a method and system for providing selective media data, which method and system provide a multimedia conference participant with a custom conference service suited to the participant's purpose in participating in the multimedia conference.

It is another object of the present invention to provide a method and system for providing selective media data in a multimedia conference service, which method and system provide a multimedia conference participant with media data selected by the participant.

It is yet another object of the present invention to provide a method and system for providing selective media data in a multimedia conference service, which method and system provide a multimedia conference participant with media data of another participant or a format selected by the participant provided with the media data.

According to an aspect of the present invention, a method for providing selective media data in a multimedia conference service comprises the steps of: transmitting, at a terminal participating in the multimedia conference, a selective media data provision request signal including media option information input by a user; selecting, at a media server, media data corresponding to the media option information of the terminal; and providing, at the media server, the selected media data to the terminal.

The selective media data provision method preferably further comprises the step of, at an application server, receiving the selective media data provision request signal from the terminal and transmitting the media option information included in the selective media data provision request signal to the media server.

The selective media data provision request signal maybe a Session Initiation Protocol (SIP) message.

The selective media data provision request signal may be an Integrated Visual Telecommunication system (INVITE) message.

The media option information may be included in the INVITE message in Extensible Markup Language (XML) format.

The application server may obtain the media option information by parsing the XML included in the INVITE message, and may transmit the obtained media option information to the media server.

The selective media data provision method preferably further comprises the step of storing, at the application server, the obtained media option information.

The media option information may comprise at least one of terminal selection information for selecting a specific terminal among terminals participating in the multimedia conference, and media data provision format selection information.

In the latter regard, the media data corresponding to the media option information may be provided by terminals indicated by the terminal selection information.

Moreover, the media data corresponding to the media option information may have a format indicated by the media option information.

In addition, the media data corresponding to the media option information may be media data having a format indicated by the media data provision format selection information among media data provided by a terminal indicated by the terminal selection information.

The step of selecting, at the media server, media data corresponding to the media option information of the terminal may convert the media data to be provided to the terminal into a format indicated by the media option information.

When the media data provided to the terminal does not include caption data and the media option information of the terminal includes information requesting provision of caption data, the media server may extract caption data from the media data and provide the terminal with the extracted caption data together with the media data.

According to another aspect of the present invention, a system for providing selective media data in a multimedia conference service comprises: a terminal for generating and transmitting a selective media data provision request signal including media option information corresponding to its own media data selection settings; and a media server for selecting media data corresponding to the media option information of the terminal among media data collected from at least one other terminal participating in the same multimedia conference, and for providing the selected media data to the terminal.

The selective media data provision system preferably further comprises an application server for receiving the selective media data provision request signal from the terminal, for obtaining the media option information from the selective media data provision request signal, and for providing the obtained media option information to the media server.

The application server may store the obtained media option information.

The terminal may provide a user with an interface for configuring the terminal's media data selection settings.

The selective media data provision request signal may be a Session Initiation Protocol Integrated Visual Telecommunication system (SIP INVITE) message, and the media option information may be included in the SIP INVITE message in XML format.

The application server may obtain the media option information by parsing the XML included in the INVITE message, and provide the obtained media option information to the media server.

The media option information may comprise at least one of terminal selection information for selecting a specific terminal among terminals participating in the multimedia conference, and media data provision format selection information.

The media server may convert the media data to be provided to the terminal into a format indicated by the media data provision format selection information included in the media option information, and provide the converted media data to the terminal.

As described above, the present invention provides a selective media data provision service for providing a conference participant with a custom conference service suited to the participant's purpose in participating in the conference, and so forth, in a multimedia conference service.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic block diagram of a multimedia conference system according to an exemplary embodiment of the present invention;

FIG. 2 is a diagram illustrating flow of signals between components shown in FIG. 1 according to an exemplary embodiment of the present invention; and

FIG. 3 shows an exemplary embodiment of a session initiation protocol (SIP) message which can be used in the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

First, the constitution of a multimedia conference system to which the present invention can be applied will be described below.

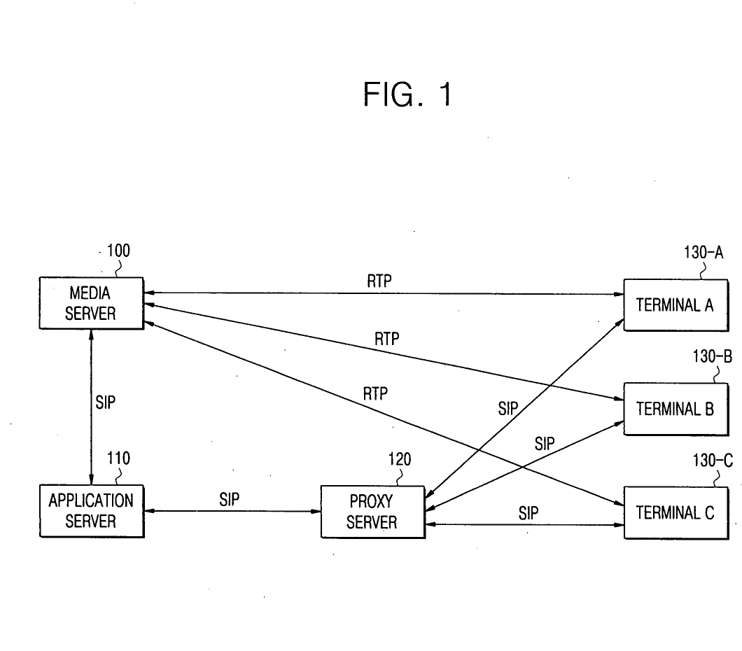

FIG. 1 is a schematic block diagram of a multimedia conference system according to an exemplary embodiment of the present invention.

As illustrated in FIG. 1, the multimedia conference system may comprise a media sever (MS) 100, an application server (AS) 110, a proxy server 120, and at least one terminal 130-A, 130-B and 130-C. Although FIG. 1 illustrates the three terminals 130-A, 130-B and 130-C, the present invention is not limited to a certain number of terminals.

In general, the MS 100 illustrated in FIG. 1 collects and mixes media data of multimedia conference participants, and provides the mixed media data to each participant in the multimedia conference. In addition, the MS 100 can provide selectively differentiated media data by performing the present invention.

Selectively differentiated media data can be provided at the request of a multimedia conference participant. More specifically, the MS 100 may provide a multimedia conference participant who requests provision of selectively differentiated media data with media data selected in correspondence to the request of the participant. For example, the MS 100 may provide the multimedia conference participant requesting provision of selectively differentiated media data with only media data from selected participants or only media data in a particular format, as requested by the participant.

In general, the AS 110 illustrated in FIG. 1 stores dialog information related to a signal of each multimedia conference participant. The AS 110 may provide the MS 100 with dialog information related to a signal received from a participant or stored therein.

In addition, in order to implement the present invention, the AS 110 may store media option information indicating media data requested by the multimedia conference participant and corresponding to media data selection settings.

The media option information corresponding to the media data selection settings of the multimedia conference participant may be included in a selective media data provision request signal and transmitted to the AS 110. In this embodiment, the selective media data provision request signal may be transmitted in Session Initiation Protocol (SIP) message format. In particular, an SIP Integrated Visual Telecommunication system (INVITE) message may be used to perform the present invention. For example, the media option information may be included in the INVITE message in Extensible Markup Language (XML) format.

The AS 110 may parse XML that includes the media option information and is included in an INVITE message received from each participant into one file, and then transmit the corresponding media option information to the MS 100.

The proxy server 120 illustrated in FIG. 1 connects the AS 110 and the terminals 130-A, 130-B and 130-C.

The terminals 130-A, 130-B and 130-C illustrated in FIG. 1 are used for multimedia conference participants to be provided with a multimedia conference service. In other words, multimedia conference participants are provided with all multimedia conference services by the terminals 130-A, 130-B and 130-C. Therefore, in the following description, the term “terminal” will be used instead of “multimedia conference participant”, except when necessary to distinguish between the two. In addition, reference numerals of terminals will be omitted, except when necessary to distinguish between terminals.

Each of the terminals is assumed to have a multimedia conference function. In particular, each terminal in this embodiment has the multimedia conference function based on an SIP/SIP Project Investigation (SIPPING) protocol, and has an option setting an interface through which a service option relating to its own media data can be selected and an SIP stack. The terminal may receive an input media data selection of a participant through the option setting interface, and set up media data selection corresponding to the input. The terminal may transmit the selective media data provision request signal including the media option information corresponding to the media data selection settings set up by the option setting interface.

The terminal may transmit the selective media data provision request signal for performing the present invention to the AS 120 through the proxy server 120. The AS 120 transmits media option information, included in the selective media data provision request signal received from the terminal, to the MS 100. In addition, media data is directly transmitted between the MS 100 and the terminal, and may be transmitted using Real-time Transport Protocol (RTP).

Relationships among the above-described components will be described below.

A terminal may access the AS 120 through the proxy server 120. The terminal transmits a selective media data provision request signal, including media option information corresponding to its own setting, to the AS 110. The AS 110 transmits the media option information, included in the selective media data provision request signal received from the terminal, to the MS 100. In addition, dialog information of each terminal related to a signal is transmitted to the AS 110. The AS 110 transmits dialog information of the terminals relating to signals and media option information of the terminals to the MS 100, and thereby can control the MS 100. The MS 100 provides the terminals with media data corresponding to the information received from the AS 110.

The present invention will be described in detail below with reference to the flow of signals between the above-described components.

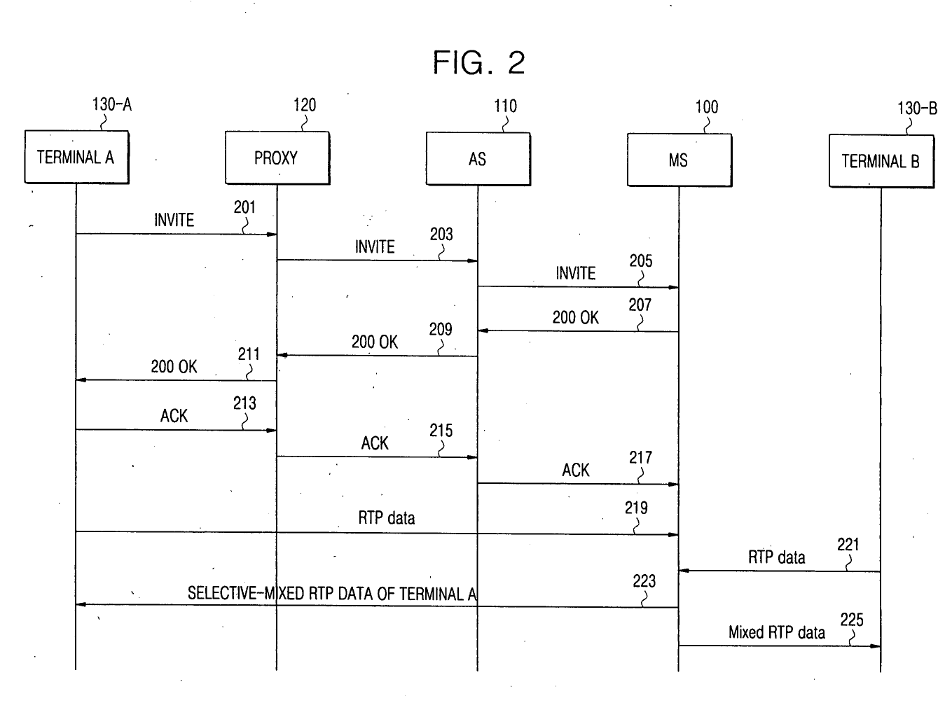

FIG. 2 is a diagram illustrating the flow of signals between the components shown in FIG. 1 according to an exemplary embodiment of the present invention.

Reference numbers 201, 203 and 205 of FIG. 2 denote media option information registration steps of the terminal A 130-A.

In step 201, the terminal A 130-A transmits a selective media data provision request signal, including media option information corresponding to its own media data selection settings, to the proxy server 120. In the latter regard, the media option information may be included in the selective media data provision request signal embodied within a SIP INVITE message in XML format, and transmitted.

In step 203, the proxy server 120 transmits the selective media data provision request signal received from the terminal to the AS 110.

In step 205, the AS 110 transmits the selective media data provision request signal received from the proxy server 120 to the MS 100.

In step 207, upon receiving the selective media data provision request signal, the MS 100 transmits a response signal indicating that the corresponding signal has been received to the AS 110. The MS 100 may use an SIP 200 OK message for the response signal. The 200 OK signal is transmitted from the AS 110 to the proxy server 120 in step 209, and is again transmitted from the proxy server 120 to the terminal A 130-A in step 211.

Meanwhile, the selective media data provision request signal transmitted by the terminal A 130-A, and including the media option information of the terminal A 130-A, may be parsed by the AS 110. The AS 110 parses the received selective media data provision request signal to obtain the media option information included in the corresponding signal, and stores the obtained media option information. The AS 110 may control the MS 100 by transmitting the obtained media option information to the MS 100. In the latter regard, the AS is 110 may combine all information received from terminals participating in a multimedia conference into one file, and transmit the file to the MS 100.

In step 213, when the 200 OK message is received, the terminal A 130-A transmits an ACK message in response to the 200 OK message. The ACK message is transmitted from the terminal A 130-A to the proxy server 120 in step 213, from the proxy server 120 to the AS 110 in step 215, and from the AS 110 to the MS 100 in step 217.

Steps 219 and 221 are media data collection processes of the MS 100. The MS 100 may collect media data from the terminals participating in the multimedia conference. The media data collection may be performed using the RTP.

Although only two terminals, the terminal A 130-A and a terminal B 130-B, are illustrated in FIG. 2, this is just an example to aid in understanding the present invention, and there is no limit to the number of terminals participating in one multimedia conference.

In step 223, the MS 100 selects media data corresponding to the media option information registered by the terminal A 130-A among the collected media data, and provides the terminal A 130-A with the selected media data. In step 225, the MS 100 mixes the collected media data as is, and provides the mixed data to the terminal B 130-B which did not register media option information.

For example, when the media option information registered by the terminal A 130-A includes terminal selection information indicating a specific terminal participating in the multimedia conference, the MS 100 may provide the terminal A 130-A with only media data collected from the terminal indicated by the terminal selection information. Meanwhile, when the media option information registered by the terminal A 130-A is media data provision format information indicating media data of a specific format, the MS 100 may provide the terminal A 130-A with only media data of the format indicated by the media data provision format information. For example, media data provision format information may indicate whether or not captions are provided to the terminal.

When the media option information registered by the terminal A 130-A includes terminal selection information and media data provision format information, the MS 100 may select media data having a format indicated by the media data provision format information, among media data collected from a terminal indicated by the terminal selection information, and may provide only the selected media data to the terminal A 130-A.

Meanwhile, when the collected media data to be provided to the terminal A 130-A does not have a media data provision format requested by the terminal A 130-A, the MS 100 may convert the media data into the format satisfying the request of the terminal A 130-A, and provide the converted media data.

For example, when the terminal A 130-A is requested to provide a caption even though the collected media data does not include caption data, the MS 100 extracts caption data from the collected media data and provides the extracted data together with the collected media data to the terminal A 130-A, thereby satisfying the request of the terminal A 130-A.

Such a caption service may cater to the visually handicapped or multimedia conference participants who want to receive multimedia conference content without sound.

In addition, the caption service described above may be provided when the MS 100 includes a real-time caption transcoder. The MS 100 may perform various kinds of media data format conversion besides caption extraction.

The present invention may be modified into other various forms, and the media data provision format information also may be embodied to indicate various service types.

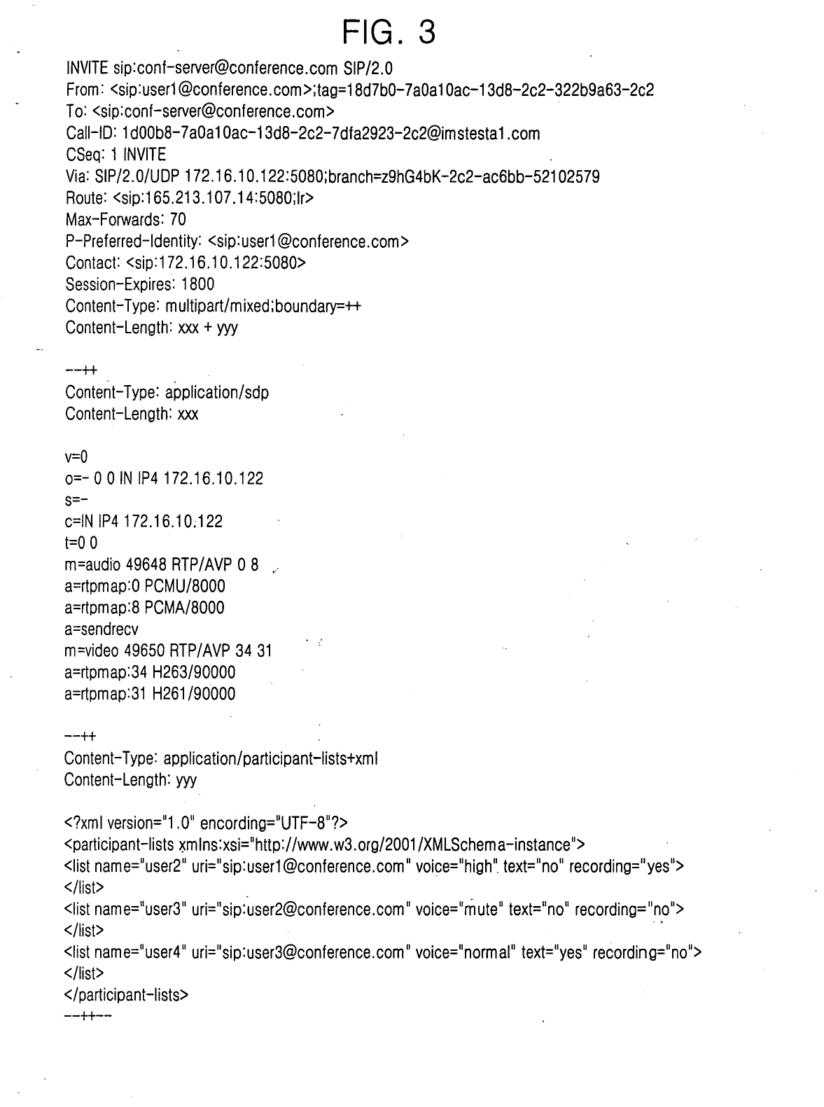

FIG. 3 shows an exemplary embodiment of a session initiation protocol (SIP) message which can be used in the present invention.

An SIP INVITE message is illustrated in FIG. 3. In particular, the section shown in bold characters in FIG. 3 includes information for implementing the present invention, and corresponds to media data selection settings of a terminal.

“Voice” in a <list> tag of FIG. 3 may denote a volume level including a mute state, “text” may denote whether or not a caption is provided, and “recording” may denote whether or not media data is recorded, i.e., whether or not video recording, sound recording, and the like are performed. “Voice”, “text” and “recording” may be included in the media data provision format information described above. The message illustrated in FIG. 3 includes information requesting provision of media data collected from a user 2 at a high volume level, media data collected from a user 3 without sound, and media data collected from a user 4 at a normal volume level. In addition, the message illustrated in FIG. 3 requests that only the media data collected from the user 4 be provided with captions, and that only the media data collected from the user 2 be recorded.

The AS 110 parses XML in an INVITE message received from each user into one file, and then provides the information to the MS 100.

SIP and SIP messages are described in Request For Comments (RFC) 3261, and thus will not be described herein.

The present invention enables multimedia conference participants to receive selective media data corresponding to each participant's request, thereby providing enhanced functionality and convenience.

While the present invention has been described with reference to exemplary embodiments thereof, it will be understood by those skilled in the art that various changes in form and detail may be made therein without departing from the scope of the present invention as defined by the following claims.

What is claimed is:

1. A method for providing selective media data in a multimedia conference service, the method comprising the steps of:
transmitting, at a terminal participating in a multimedia conference, a selective media data provision request signal including media option information inputted by a user;
selecting, at a media server, media data corresponding to the media option information inputted by the user; and
providing, at the media server, the selected media data to the terminal.

2. The method according to claim 1, further comprising the steps of:
receiving, at an application server, the selective media data provision request signal transmitted from the terminal; and
transmitting the media option information included in the selective media data provision request signal to the media server.

3. The method according to claim 2, wherein the selective media data provision request signal is a Session Initiation Protocol (SIP) message.

4. The method according to claim 2, wherein the selective media data provision request signal is an Integrated Visual Telecommunication system (INVITE) message.

5. The method according to claim 4, wherein the media option information is included in the INVITE message in Extensible Markup Language (XML) format.

6. The method according to claim 5, wherein the media option information is obtained at the application server by parsing the XML included in the INVITE message, and the obtained media option information is transmitted to the media server.

7. The method according to claim 6, further comprising the step of storing, at the application server, the obtained media option information.

8. The method according to claim 1, wherein the media option information includes at least one of terminal selection information for selecting a specific terminal among terminals participating in the multimedia conference, and media data provision format selection information.

9. The method according to claim 8, wherein the media data corresponding to the media option information is provided by terminals indicated by the terminal selection information.

10. The method according to claim 8, wherein the media data corresponding to the media option information has a format indicated by the media option information inputted by the user.

11. The method according to claim 8, wherein the media data corresponding to the media option information is media data having a format indicated by the media data provision format selection information among media data provided by a terminal indicated by the terminal selection information.

12. The method according to claim 8, wherein the step of selecting, at the media server, media data corresponding to the media option information of the terminal comprises converting the selected media data to be provided to the terminal into a format indicated by the media data provision format selection information.

13. The method according to claim 12, wherein when the selected media data provided to the terminal does not include caption data and the media option information of the terminal includes information requesting provision of caption data, the media server extracts caption data from the selected media data and provides the extracted caption data, together with the selected media data, to the terminal.

14. A system for providing selective media data in a multimedia conference service, comprising:
a first terminal for generating and transmitting a selective media data provision request signal including media option information corresponding to media data selection settings of the first terminal; and
a media server for selecting media data corresponding to the media option information among media data collected from at least one other terminal participating in the same multimedia conference, and for providing the selected media data to the first terminal.

15. The system according to claim 14, further comprising an application server for receiving the selective media data provision request signal from the first terminal, for obtaining the media option information from the selective media data provision request signal, and for providing the obtained media option information to the media server.

16. The system according to claim 15, wherein the application server stores the obtained media option information.

17. The system according to claim 14, wherein the first terminal provides a user with an interface for configuring the media data selection settings of the first terminal.

18. The system according to claim 14, wherein the selective media data provision request signal is a Session Initiation Protocol (SIP) Integrated Visual Telecommunication system (INVITE) message, and the media option information is included in the SIP INVITE message in Extensible Markup Language (XML) format.

19. The system according to claim 18, further comprising an application server which obtains the media option information by parsing the XML included in the INVITE message, and which transmits the obtained media option information to the media server.

20. The system according to claim 14, wherein the media option information includes at least one of terminal selection information for selecting a specific terminal among terminals participating in the multimedia conference and media data provision format selection information.

21. The system according to claim 20, wherein the media server converts the selected media data to be provided to the first terminal into a format indicated by the media option information, and provides the converted media data to the first terminal.
